(19) United States
(12) Patent Application Publication
(10) Pub. No.: US 2025/0211012 A1
(43) Pub. Date: Jun. 26, 2025

(54) POWER CONTROL SYSTEM USING STATE OF CHARGE FROM SMART LITHIUM-ION BATTERY AND FAILOVER ALGORITHM

(71) Applicant: Vertiv Corporation, Westerville, OH (US)

(72) Inventors: GUSTAF WESLIEN, Stockhom (SE); CHETANA BHAT, Pune (IN); DAVID WILLIAM PELL WILSON, Almonte (CA)

(21) Appl. No.: 18/989,914

(22) Filed: Dec. 20, 2024

(30) Foreign Application Priority Data
Dec. 22, 2023 (IN) 202321088096

(51) Int. Cl. H02J 7/00

(52) U.S. Cl. CPC H02J 7/0068; H02J 7/0048; H02J 2300/10

(57) ABSTRACT

A system for controlling a diesel generator includes a controller configured to: receive, via a communication protocol interface, a state of change value associated with at least one battery; calculate a battery capacity for the at least one battery based on the state of charge value; determine a state of at least one diesel generator; and change the state of the at least one diesel generator based on the determined state of the at least one diesel generator and the battery capacity of the at least one battery.

### CROSS REFERENCE TO RELATED APPLICATIONS

This U.S. Non-Provisional patent application claims the benefit of Indian Provisional Patent Application No. 202321088096 titled “Power Control System By SOC From Smart Lithium-Ion Battery & Failover Algorithm” filed Dec. 22, 2023, the entire disclosure of which is hereby incorporated by reference.

### FIELD

The present disclosure relates to the field of power systems and energy management, particularly this disclosure relates to a system for power control by using state of charge (SOC) from smart lithium-ion battery.

### BACKGROUND

The background information herein below relates to the present disclosure but is not necessarily prior art.

In a traditional approach to Diesel Generator (DG) control, the decision-making process for turning the generator on or off relies heavily on the shunt current and voltage calculations. These calculations are performed by a control unit, designed for monitoring and controlling DC power systems.

However, this method has inherent limitations, lacking the precision and flexibility required for optimal energy management. Shunt measurements often provide an approximation of the state of the battery, leading to suboptimal performance and occasional inefficiencies in the DG's operation. This is a technical problem.

### SUMMARY

An aspect of the disclosed embodiments includes a system for controlling a diesel generator. The system includes a controller configured to: receive, via a communication protocol interface, a state of change value associated with at least one battery; calculate a battery capacity for the at least one battery based on the state of charge value; determine a state of at least one diesel generator; and change the state of the at least one diesel generator based on the determined state of the at least one diesel generator and the battery capacity of the at least one battery.

Another aspect of the disclosed embodiments includes a method for controlling a diesel generator. The method includes: receiving, via a communication protocol interface, a state of change value associated with at least one battery; calculating a battery capacity for the at least one battery based on the state of charge value; determining a state of at least one diesel generator; and changing the state of the at least one diesel generator based on the determined state of the at least one diesel generator and the battery capacity of the at least one battery.

### BRIEF DESCRIPTION OF THE ACCOMPANYING DRAWING

The power control system by SOC from smart lithium-ion battery via a communication protocol channel and failover algorithm of the present disclosure will now be described with the help of the accompanying drawing, in which:

FIG. 1 illustrates the working of smart lithium-ion battery-based diesel generator control system with a communication protocol channel in accordance with an embodiment of the present disclosure.

FIG. 2 illustrates a flow chart of working of the smart lithium-ion battery-powered diesel generator control system with a communication protocol channel in accordance with an embodiment of the present disclosure.

FIG. 3 illustrates a flow chart to illustrate two-way communication for the actuation of diesel generator (DG) via a communication protocol channel and via the smart lithium-ion battery in accordance with an embodiment of the present disclosure.

FIG. 4 illustrates a flow chart to illustrate the actuation of diesel generator (DG) via the smart lithium-ion battery when a communication protocol channel fails in accordance with an embodiment of the present disclosure.

### DETAILED DESCRIPTION

Embodiments, of the present disclosure, will now be described with reference to the accompanying drawing.

Embodiments are provided so as to thoroughly and fully convey the scope of the present disclosure to a person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, elements, modules, units, and/or components, but do not forbid the presence or addition of one or more other features, elements, components, and/or groups thereof.

In the traditional approach to DG control, the decision-making process for turning the generator on or off relied heavily on shunt current and voltage calculations. These calculations are performed by the control unit for monitoring and controlling DC power systems. However, this method has inherent limitations, lacking the precision and flexibility required for optimal energy management. Shunt measurements often provide an approximation of the state of the battery, leading to suboptimal performance and occasional inefficiencies in the DG's operation. Therefore, there is a need for a more advanced and accurate system to enhance control and ensure seamless integration of DGs into modern power management frameworks.

The disclosure introduces, in this context, a paradigm shift in DG control mechanisms. By incorporating a communication protocol technology, the system gains direct access to SOC data from smart lithium-ion batteries. This transition from shunt-based calculations to real-time data retrieval from intelligent batteries marks a significant technical advantage as a technical solution to the aforementioned technical problem in precision and efficiency. The control unit interacts with smart lithium-ion batteries via a communication protocol, facilitating the exchange of information critical for decision-making. This evolution in technology not only addresses the limitations of the traditional shunt method but also lays the foundation for a more adaptable and responsive DG control system, optimizing energy utilization in a dynamic and modern power landscape.

In some embodiments, the systems and methods described herein may be configured to ameliorate one or more problems of the prior art or to at least provide a useful alternative. The systems and methods described herein may be configured to provide a system that can enhance the control mechanism of DG. The systems and methods described herein may be configured to provide a system that can integrate smart lithium-ion batteries equipped with advanced battery management systems (BMS) into the DG. The systems and methods described herein may be configured to provide a system that can employ an interface communication protocol channel as the conduit between the control unit and smart lithium-ion batteries.

The systems and methods described herein may be configured to provide a system that can address the inherent risks associated with communication failures. The systems and methods described herein may be configured to provide a system that can enhance control and ensure the seamless integration of diesel generators into modern power management frameworks.

The systems and methods described herein may be configured to provide a power control system by SOC from smart lithium-ion battery via communication and failover algorithm. The systems and methods described herein may be configured to enhance the control mechanism of DG. The systems and methods described herein may be configured to obtain SOC data from smart lithium-ion batteries through a communication channel. The systems and methods described herein may be configured to offer a more accurate representation of the actual battery state compared to shunt current and voltage calculations. The systems and methods described herein may be configured to provide higher precision in controlling the operation (ON/OFF) of the DG by using SOC from the smart lithium-ion battery.

The systems and methods described herein may be configured to provide precise SOC data for DG control. The systems and methods described herein may be configured to integrate smart lithium-ion batteries equipped with advanced battery management systems (BMS) into the DG. The systems and methods described herein may be configured to direct access to SOC data and to facilitate precise control, optimizing the performance of the DG system and maximizing the lifespan of the smart lithium-ion batteries.

The systems and methods described herein may be configured to address the inherent risks associated with communication failures. The systems and methods described herein may be configured to retrieve SOC data from the batteries, optimizing DG turn on/off decisions. The systems and methods described herein may be configured to employ an embedded system communication as the conduit between the control unit and smart lithium-ion batteries.

The systems and methods described herein may be configured to ensure seamless operation by shifting to a traditional “back-up” battery mode in the event of a communication channel failure. The systems and methods described herein may be configured to use the embedded system communication channel to allow for a more dynamic and flexible controllable system, adapting to the varying needs and conditions of the power system.

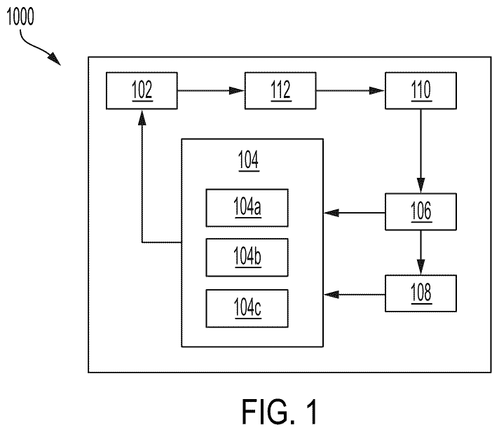

FIG. 1 shows the working of smart lithium-ion battery-powered power control system.

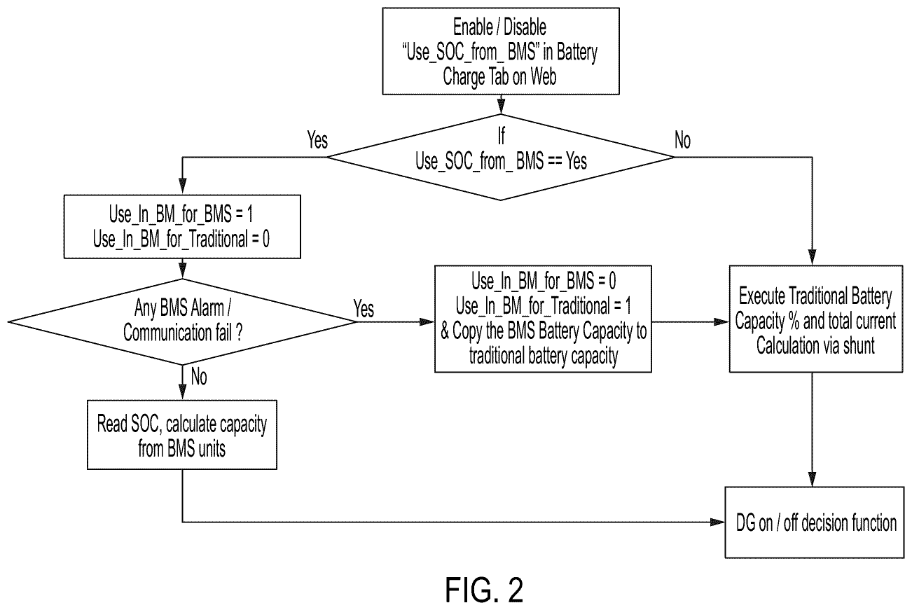

FIG. 2 illustrates a flow chart of working of the smart lithium-ion battery-powered power control system with a communication protocol in accordance with an embodiment of the present disclosure.

The system (1000) is a sophisticated power management setup designed to control a DG (102) based on real-time SOC data obtained from a plurality of smart lithium-ion batteries, each equipped with its BMS (108). The central brain of this system (1000) is the control unit (104), which orchestrates the communication and decision-making processes.

Communication between the control unit (104) and the system (1000) is established through a communication protocol interface (104b), facilitating the retrieval of SOC data for optimal DG (102) control. The control logic dictates that the DG (102) and its operational state, whether to turn on or off, is determined by the SOC information obtained from these batteries.

To ensure resilience in the face of communication challenges, a failover mechanism is integrated into the system (1000) in accordance with an embodiment of this disclosure. In the event of a communication protocol interface (104b) failure, the system (1000) seamlessly transitions to a traditional capacity calculation approach. This involves the use of a shunt (106) to determine battery capacity, enabling continuous DG (102) operation even when direct communication with the smart lithium-ion batteries is disrupted.

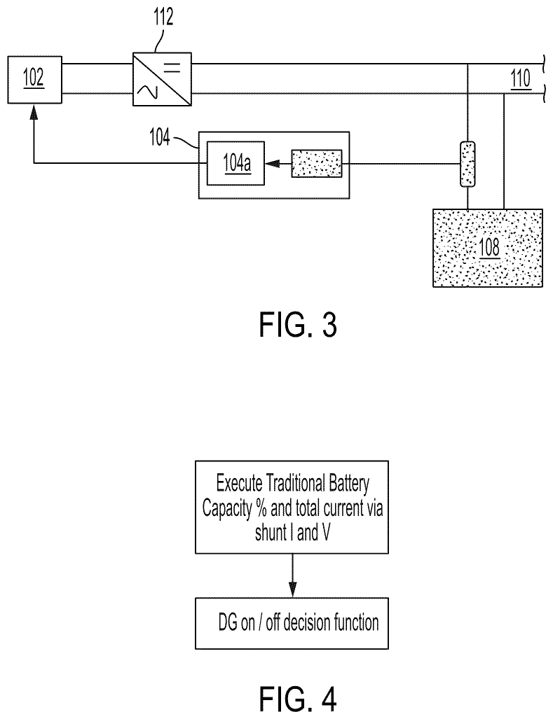

In an embodiment, the switching on/off the DGs using state of charge (SOC) read from smart lithium-ion batteries via the communication protocol interface effectively controls the power output of a hybrid system that combines DG and battery energy storage. This system (1000) can provide a better control than the traditional mechanisms via battery shunt, which is a device that measures the current flowing through the battery by measuring the voltage drop across a known resistance. The communication protocol interface allows the system (1000) to send and receive data from the smart battery and the DG controller over serial or Ethernet networks. This enables remote monitoring and control of the hybrid system, as well as data logging and analysis. FIG. 3 illustrates a flow chart to illustrate two-way communication for the actuation of the DG via the communication protocol interface and via the smart lithium-ion battery in accordance with an embodiment of the present disclosure.

However, if the communication protocol interface fails, a unique algorithm may be configured within the control unit (104) for shifting over to traditional “back-up” battery to continue running the DG turn on/off decision-making function. FIG. 4 illustrates a flow chart to illustrate the actuation of the DG via the smart lithium-ion battery when the communication protocol fails in accordance with an embodiment of the present disclosure.

The system (1000) monitors the communication protocol interface status using the rectifier (112) and the control unit (104). Therefore, if the communication is lost for more than a predefined time, the system (1000) assumes that the communication protocol or the network is faulty and switches to a backup battery mode. In the backup mode, the system (1000) uses the SOC read from the smart lithium-ion battery as the primary input for the DG control logic. The system (1000) also uses a backup battery shunt to measure the current flowing through the battery and compare it with a threshold value.

When the communication channel between control unit and lithium-ion batteries starts working again, the system (1000) will be restored to its normal mode by re-establishing communication with the battery. In this scenario, the SOC value read from the smart lithium-ion battery will be used instead of the backup battery mode.

A microcontroller (104a) plays a role in executing control algorithms, ensuring efficient communication between components and the control unit (104). The presence of a communication protocol interface (104b) circuit signifies the communication interface responsible for exchanging data between the control unit (104) and the individual BMS (108) units.

Moreover, the system (1000) is designed with user customization in mind, allowing for flexibility through parameters such as “use SOC from BMS (108).” This feature empowers users to tailor the operation of the system (1000) according to specific requirements, enhancing adaptability. This is achieved by leveraging SOC data from smart lithium-ion batteries through the communication protocol interface.

In essence, this comprehensive architecture combines cutting-edge technology, failover mechanisms, and user-configurable parameters to create an intelligent power management system (1000). The integration of a communication protocol interface (104b), failover algorithms, and traditional capacity calculation methods ensures both efficiency and resilience in critical power scenarios, making it a robust solution for DG (102) control and reliable power supply.

In some embodiments, a system for controlling a diesel generator includes a controller configured to: receive, via a communication protocol interface, a state of change value associated with at least one battery; calculate a battery capacity for the at least one battery based on the state of charge value; determine a state of at least one diesel generator; and change the state of the at least one diesel generator based on the determined state of the at least one diesel generator and the battery capacity of the at least one battery.

In some embodiments, the at least one battery includes at least one lithium-ion battery. In some embodiments, the at least one battery includes at least one smart battery. In some embodiments, the at least one smart battery includes a battery management system. In some embodiments, the communication protocol interface is facilitated via an interface channel. In some embodiments, the controller is further configured to monitor, via a rectifier, the communication protocol interface. In some embodiments, the controller is further configured to determine, using the rectifier, whether the communication protocol interface has an associated failure. In some embodiments, the controller is further configured to, in response to a determination that the communication protocol interface has an associated failure, initiate a back-up mode. In some embodiments, the controller is further configured to, in response to initiating the back-up mode, use a shunt to determine a current value associated with the at least one battery. In some embodiments, the controller is further configured to use the determined current value to determine the battery capacity of the at least one battery.

In some embodiments, a method for controlling a diesel generator includes: receiving, via a communication protocol interface, a state of change value associated with at least one battery; calculating a battery capacity for the at least one battery based on the state of charge value; determining a state of at least one diesel generator; and changing the state of the at least one diesel generator based on the determined state of the at least one diesel generator and the battery capacity of the at least one battery.

In some embodiments, the at least one battery includes at least one lithium-ion battery. In some embodiments, the at least one battery includes at least one smart battery. In some embodiments, the at least one smart battery includes a battery management system. In some embodiments, the communication protocol interface is facilitated via an interface channel. In some embodiments, the method also includes monitoring, via a rectifier, the communication protocol interface. In some embodiments, the method also includes determining, using the rectifier, whether the communication protocol interface has an associated failure. In some embodiments, the method also includes, in response to a determination that the communication protocol interface has an associated failure, initiating a back-up mode. In some embodiments, the method also includes, in response to initiating the back-up mode, using a shunt to determine a current value associated with the at least one battery. In some embodiments, the method also includes using the determined current value to determine the battery capacity of the at least one battery.

The foregoing description of the embodiments has been provided for purposes of illustration and not intended to limit the scope of the present disclosure. Individual components of a particular embodiment are generally not limited to that particular embodiment, but are interchangeable. Such variations are not to be regarded as a departure from the present disclosure, and all such modifications are considered to be within the scope of the present disclosure.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, or group of elements, but not the exclusion of any other element, or group of elements.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

What is claimed is:

1. A system for controlling a diesel generator, the system comprising:
a controller configured to:
receive, via a communication protocol interface, a state of change value associated with at least one battery;
calculate a battery capacity for the at least one battery based on the state of charge value;
determine a state of at least one diesel generator; and
change the state of the at least one diesel generator based on the determined state of the at least one diesel generator and the battery capacity of the at least one battery.

2. The system of claim 1, wherein the at least one battery includes at least one lithium-ion battery.

3. The system of claim 1, wherein the at least one battery includes at least one smart battery.

4. The system of claim 3, wherein the at least one smart battery includes a battery management system.

5. The system of claim 1, wherein the communication protocol interface is facilitated via an interface channel.

6. The system of claim 1, wherein the controller is further configured to monitor, via a rectifier, the communication protocol interface.

7. The system of claim 6, wherein the controller is further configured to determine, using the rectifier, whether the communication protocol interface has an associated failure.

8. The system of claim 7, wherein the controller is further configured to, in response to a determination that the communication protocol interface has an associated failure, initiate a back-up mode.

9. The system of claim 8, wherein the controller is further configured to, in response to initiating the back-up mode, use a shunt to determine a current value associated with the at least one battery.

10. The system of claim 9, wherein the controller is further configured to use the determined current value to determine the battery capacity of the at least one battery.

11. A method for controlling a diesel generator, the method comprising:
receiving, via a communication protocol interface, a state of change value associated with at least one battery;
calculating a battery capacity for the at least one battery based on the state of charge value;
determining a state of at least one diesel generator; and
changing the state of the at least one diesel generator based on the determined state of the at least one diesel generator and the battery capacity of the at least one battery.

12. The method of claim 11, wherein the at least one battery includes at least one lithium-ion battery.

13. The method of claim 11, wherein the at least one battery includes at least one smart battery.

14. The method of claim 13, wherein the at least one smart battery includes a battery management system.

15. The method of claim 11, wherein the communication protocol interface is facilitated via an interface channel.

16. The method of claim 11, further comprising monitoring, via a rectifier, the communication protocol interface.

17. The method of claim 16, further comprising determining, using the rectifier, whether the communication protocol interface has an associated failure.

18. The method of claim 17, further comprising, in response to a determination that the communication protocol interface has an associated failure, initiating a back-up mode.

19. The method of claim 18, further comprising, in response to initiating the back-up mode, using a shunt to determine a current value associated with the at least one battery.

20. The method of claim 19, further comprising using the determined current value to determine the battery capacity of the at least one battery.
